(19) United States
(12) Patent Application Publication
(10) Pub. No.: US 2019/0016902 A1
(43) Pub. Date: Jan. 17, 2019

(54) LIQUID-REPELLENT MODIFIED SILICA COATED SURFACES

(71) Applicant: Colorado State University Research Foundation, Fort Collins, CO (US)

(72) Inventors: Arun K. KOTA, Fort Collins, CO (US); Wei WANG, Fort Collins, CO (US)

(73) Assignee: Colorado State University Research Foundation, Fort Collins, CO (US)

(21) Appl. No.: 16/032,649

(22) Filed: Jul. 11, 2018

Related U.S. Application Data
(60) Provisional application No. 62/530,973, filed on Jul. 11, 2017.

(51) Int. Cl. C09D 5/16; C07F 7/18

(52) U.S. Cl. CPC C09D 5/1681; C07F 7/18

(57) ABSTRACT

The invention provides a method to design and fabricate organically modified silica particles (Ormosils) and sustainable Ormosils-based omniphobic or superomniphobic surfaces using short chain fluorocarbon molecules. The disclosed Ormosils-based liquid-repellant surfaces possess superior liquid-repellency that is equivalent to long chain fluorocarbon-based surfaces, for both high surface tension liquids (e.g., water) and low surface tension liquids (e.g., oils and alcohols).

### RELATED APPLICATIONS

This application claims priority under 35 U.S.C. § 119(e) to U.S. Provisional Patent Application No. 62/530,973, filed Jul. 11, 2017, which is incorporated herein by reference.

### BACKGROUND OF THE INVENTION

Liquid-repellent surfaces can be broadly classified as hydrophobic/superhydrophobic or omniphobic/superomniphobic. Hydrophobic/superhydrophobic surfaces are repellent only to water or aqueous liquids. Omniphobic/superomniphobic surfaces are repellent to virtually any liquid—aqueous or organic, acid or base or solvent, and Newtonian or non-Newtonian. Virtually any liquid can bead up, bounce, easily slip past and roll off superomniphobic surfaces. Due to their unique and exceptional functionalities, omniphobic/superomniphobic surfaces have a wide range of practical applications including (but not limited to) corrosion prevention, fluid drag reduction, liquid waste reduction, chemical shielding, self-cleaning, anti-fouling, anti-bacteria, gravity-driven membrane separation, and enhanced condensation heat transfer coefficients.

Prior theoretical as well as experimental work showed that omniphobic/superomniphobic surfaces can be systematically designed using a combination of (1) a surface chemistry possessing a low solid surface energy (e.g., fluorocarbon chemistry), and (2) a specific type of structure called the re-entrant structure (i.e., convex or overhang structures such as spheres, cylinders, mushroom-like structures etc). Most reports on fabrication of omniphobic/superomniphobic surfaces tend to utilize long chain fluorocarbon materials containing at least 8 perfluorinated carbons. This is because such long chain fluorocarbon materials possess extremely low surface energy (approx. 10 mN/m) and are consequently highly liquid-repellent. However, such long chain fluorocarbon materials are considered “emerging contaminants” by the Environmental Protection Agency (EPA) because of their potential decomposition into perfluorooctanoic acid (PFOA), which is bioaccumulative and toxic to humans.

With the EPA gradually phasing out long chain fluorocarbon materials, the long chain fluorocarbon materials may not be available in the future for the preparation of liquid-repellent surfaces because of their bio-accumulation and/or toxicity. Accordingly, there is a need for more environmental friendly liquid-repellent coatings that are equally effective as or better than existing technologies.

### SUMMARY

This disclosure provides compositions and methods of forming omniphobic/superomniphobic coatings from organically modified silica particles (Ormosils).

Accordingly, this disclosure provides a silica particle comprising G1

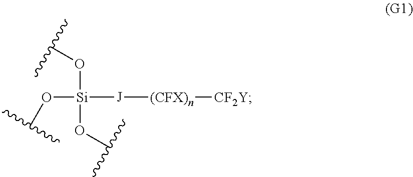

wherein
J is —(CH₂)ₘ—, —CH₂—O—CH₂—, an amide, urea, imide, or carbamate;
each X is independently H or F;
Y is H or F;
m is 2-6; and
n is 1-3;

wherein the silica particle has a diameter of about 0.001 micrometers to about 100 micrometers.

In one aspect of the disclosure, a substrate is coated with a plurality of the above silica particles wherein the surface of the coated substrate is liquid-repellant.

This disclosure also provides a liquid-repellant surface comprising a substrate coated with modified silica particles, wherein the modified silica particles are formed by hydrolysis and condensation of a compound of Formula A:

Si(Q^{a})₃-J-(CFX)ₙ—CF₂Y (A);

and a compound of Formula B:

Si(Q^{b})₄ (B);

wherein
Q^{a} and Q^{b} are each independently halo or —OR;
J is —(CH₂)ₘ—, —CH₂—O—CH₂—, an amide, urea, imide, or carbamate;
each X is independently H or F;
Y is H or F;
m is 2-6;
n is 1-3; and
each R is independently branched or unbranched —(C₁-C₆)alkyl;

wherein the mole ratio of compounds A:B is about 0.5 or greater and the surface of the coated substrate is liquid-repellant.

Additionally, this disclosure provides a method of forming a liquid-repellant surface comprising:
a) mixing
   a compound of Formula C:

Si(OR^{a})₃—(CH₂)ₘ—(CFX)ₙ—CF₂Y (C);

a compound of Formula D:

Si(OR^{b})₄ (D);

wherein R^{a} and R^{b} are each independently branched or unbranched —(C₁-C₆)alkyl;
each X is independently H or F;
Y is H or F;
m is 2-6; and
n is 1-3;
   water, a base, and a solvent, to form organically modified silica particles (Ormosils);
b) isolating the Ormosils; and
c) coating a substrate with Ormosils;

wherein the Ormosils have a diameter of about 0.001 micrometers to about 100 micrometers;

wherein the mole ratio of compounds C:D is about 0.5 or greater and the coated substrate has a liquid-repellant surface; and

wherein a liquid in contact with the liquid-repellant surface has a contact angle of about 90 degrees or more.

In other aspects of this disclosure, the Ormosils have an environmental half-life that is sufficiently short to minimize bioaccumulation compared to other Ormosils.

The invention provides novel modified silica particles according to Formula G1 and Formula G2, intermediates for the synthesis of modified silica particles according to Formula G1 and Formula G2, as well as methods of preparing modified silica particles according to Formulas G1 and G2. The invention also provides modified silica particles according to Formulas G1 and G2 that are useful as intermediates for the synthesis of other modified silica particles.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1. Schematics depicting (a) the conventional Stöber synthesis of silica particles and post-functionalization with a fluorocarbon silane to form liquid-repellent Ormosils, and (b) the modified Stöber synthesis with in-situ functionalization of silica particles with a fluorocarbon silane to form liquid-repellent Ormosils.

FIG. 2. Scanning electron microscope (SEM) image showing the morphology of in-situ functionalized short chain fluorocarbon-based Ormosils synthesized at different molar ratio a of nonafluorohexyltriethoxysilane to TEOS.

FIG. 3. (a) Apparent contact angles and (b) roll off angles, respectively, of n-hexadecane and water droplets on Ormosils-based superomniphobic surfaces.

FIG. 4. (a) A series of snapshots showing a droplet of n-hexadecane rolling off from the short chain fluorocarbon-based Ormosils superomniphobic surface. (b) A series of snapshots showing a droplet of n-hexadecane bouncing on the short chain fluorocarbon-based Ormosils superomniphobic surface.

### DETAILED DESCRIPTION

In this work, a method was developed to design and fabricate, for the first-time, organically modified silica particles (Ormosils) and sustainable Ormosils-based superomniphobic surfaces using short chain fluorocarbon molecules. The disclosed Ormosils-based omniphobic or superomniphobic surfaces with short chain fluorocarbon molecules possess liquid-repellency that is equivalent to long chain fluorocarbon-based surfaces, for both high surface tension liquids (e.g., water) and low surface tension liquids (e.g., oils and alcohols).

The underlying reason for the observed surprising result is possibly due to the modifications to the Stöber synthesis, as described herein, which provided 1) a high degree of surface coverage by the short chain fluorocarbon molecules on a silica particle, and/or 2) a high surface crystallinity (i.e., highly ordered molecular structure) on a silica particle.

### Definitions

The following definitions are included to provide a clear and consistent understanding of the specification and claims. As used herein, the recited terms have the following meanings. All other terms and phrases used in this specification have their ordinary meanings as one of skill in the art would understand. Such ordinary meanings may be obtained by reference to technical dictionaries, such as Hawley's Condensed Chemical Dictionary 14^{th} Edition, by R. J. Lewis, John Wiley & Sons, New York, N.Y., 2001.

References in the specification to “one embodiment”, “an embodiment”, etc., indicate that the embodiment described may include a particular aspect, feature, structure, moiety, or characteristic, but not every embodiment necessarily includes that aspect, feature, structure, moiety, or characteristic. Moreover, such phrases may, but do not necessarily, refer to the same embodiment referred to in other portions of the specification. Further, when a particular aspect, feature, structure, moiety, or characteristic is described in connection with an embodiment, it is within the knowledge of one skilled in the art to affect or connect such aspect, feature, structure, moiety, or characteristic with other embodiments, whether or not explicitly described.

The singular forms “a,” “an,” and “the” include plural reference unless the context clearly dictates otherwise. Thus, for example, a reference to “a compound” includes a plurality of such compounds, so that a compound X includes a plurality of compounds X. It is further noted that the claims may be drafted to exclude any optional element. As such, this statement is intended to serve as antecedent basis for the use of exclusive terminology, such as “solely,” “only,” and the like, in connection with any element described herein, and/or the recitation of claim elements or use of “negative” limitations.

The term “and/or” means any one of the items, any combination of the items, or all of the items with which this term is associated. The phrases “one or more” and “at least one” are readily understood by one of skill in the art, particularly when read in context of its usage. For example, the phrase can mean one, two, three, four, five, six, ten, 100, or any upper limit approximately 10, 100, or 1000 times higher than a recited lower limit.

As will be understood by the skilled artisan, all numbers, including those expressing quantities of ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements. When values are expressed as approximations, by use of the antecedent “about,” it will be understood that the particular value without the modifier “about” also forms a further aspect.

The terms “about” and “approximately” are used interchangeably. Both terms can refer to a variation of ±5%, ±10%, ±20%, or ±25% of the value specified. For example, “about 50” percent can in some embodiments carry a variation from 45 to 55 percent, or as otherwise defined by a particular claim. For integer ranges, the term “about” can include one or two integers greater than and/or less than a recited integer at each end of the range. Unless indicated otherwise herein, the terms “about” and “approximately” are intended to include values, e.g., weight percentages, proximate to the recited range that are equivalent in terms of the functionality of the individual ingredient, composition, or embodiment. The terms “about” and “approximately” can also modify the end-points of a recited range as discussed above in this paragraph.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. It is therefore understood that each unit between two particular units are also disclosed. For example, if 10 to 15 is disclosed, then 11, 12, 13, and 14 are also disclosed, individually, and as part of a range. A recited range (e.g., weight percentages or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc. As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents. It will be further understood that the endpoints of each of the ranges are significant both in relation to the other endpoint, and independently of the other endpoint.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, for use in an explicit negative limitation.

The term “contacting” refers to the act of touching, making contact, or of bringing to immediate or close proximity, including at the cellular or molecular level, for example, to bring about a physiological reaction, a chemical reaction, or a physical change, e.g., in a solution, in a reaction mixture, in vitro, or in vivo.

An “effective amount” refers to an amount effective to bring about a recited effect, such as an amount necessary to form products in a reaction mixture. Determination of an effective amount is typically within the capacity of persons skilled in the art, especially in light of the detailed disclosure provided herein. The term “effective amount” is intended to include an amount of a compound or reagent described herein, or an amount of a combination of compounds or reagents described herein, e.g., that is effective to form products in a reaction mixture. Thus, an “effective amount” generally means an amount that provides the desired effect.

The term “substantially” as used herein, is a broad term and is used in its ordinary sense, including, without limitation, being largely but not necessarily wholly that which is specified. For example, the term could refer to a numerical value that may not be 100% the full numerical value. The full numerical value may be less by about 1%, about 2%, about 3%, about 4%, about 5%, about 6%, about 7%, about 8%, about 9%, about 10%, about 15%, or about 20%.

This disclosure provides methods of making the compounds and compositions of the invention. The compounds and compositions can be prepared by any of the applicable techniques described herein, optionally in combination with standard techniques of organic synthesis. Many techniques such as etherification and esterification are well known in the art. However, many of these techniques are elaborated in Compendium of Organic Synthetic Methods (John Wiley & Sons, New York), Vol. 1, Ian T. Harrison and Shuyen Harrison, 1971; Vol. 2, Ian T. Harrison and Shuyen Harrison, 1974; Vol. 3, Louis S. Hegedus and Leroy Wade, 1977; Vol. 4, Leroy G. Wade, Jr., 1980; Vol. 5, Leroy G. Wade, Jr., 1984; and Vol. 6; as well as standard organic reference texts such as March's Advanced Organic Chemistry: Reactions, Mechanisms, and Structure, 5th Ed., by M. B. Smith and J. March (John Wiley & Sons, New York, 2001); Comprehensive Organic Synthesis. Selectivity, Strategy & Efficiency in Modern Organic Chemistry. In 9 Volumes, Barry M. Trost, Editor-in-Chief (Pergamon Press, New York, 1993 printing); Advanced Organic Chemistry, Part B: Reactions and Synthesis, Second Edition, Cary and Sundberg (1983);

The formulas and compounds described herein can be modified using protecting groups. Suitable amino and carboxy protecting groups are known to those skilled in the art (see for example, Protecting Groups in Organic Synthesis, Second Edition, Greene, T. W., and Wutz, P. G. M., John Wiley & Sons, New York, and references cited therein; Philip J. Kocienski; Protecting Groups (Georg Thieme Verlag Stuttgart, New York, 1994), and references cited therein); and Comprehensive Organic Transformations, Larock, R. C., Second Edition, John Wiley & Sons, New York (1999), and referenced cited therein.

As used herein, the term “substituted” or “substituent” is intended to indicate that one or more (for example., 1-20 in various embodiments, 1-10 in other embodiments, 1, 2, 3, 4, or 5; in some embodiments 1, 2, or 3; and in other embodiments 1 or 2) hydrogens on the group indicated in the expression using “substituted” (or “substituent”) is replaced with a selection from the indicated group(s), or with a suitable group known to those of skill in the art, provided that the indicated atom's normal valency is not exceeded, and that the substitution results in a stable compound.

The term “halo” or “halide” refers to fluoro, chloro, bromo, or iodo. Similarly, the term “halogen” refers to fluorine, chlorine, bromine, and iodine.

The term “alkyl” refers to a branched or unbranched hydrocarbon having, for example, from 1-20 carbon atoms, and often 1-12, 1-10, 1-8, 1-6, or 1-4 carbon atoms. As used herein, the term “alkyl” also encompasses a “cycloalkyl”, defined below.

The term “cycloalkyl” refers to cyclic alkyl groups of, for example, from 3 to 10 carbon atoms having a single cyclic ring or multiple condensed rings.

The term, “repeat unit”, “repeating unit”, or “block” as used herein refers to the moiety of a polymer that is repetitive. The repeat unit may comprise one or more repeat units, labeled as, for example, repeat unit A, repeat unit B, repeat unit C, etc. Repeat units A-C, for example, may be covalently bound together to form a combined repeat unit. Monomers or a combination of one or more different monomers can be combined to form a (combined) repeat unit of a polymer or copolymer.

The term “molecular weight” for the copolymers disclosed herein refers to the average number molecular weight (Mn). The corresponding weight average molecular weight (Mw) can be determined from other disclosed parameters by methods (e.g., by calculation) known to the skilled artisan.

### Embodiments of the Invention

The classical Stöber process is a chemical process used to prepare silica (SiO₂) particles of controllable and uniform size for applications in materials science and is the most widely used wet chemistry synthetic approach to silica nanoparticles. It is a sol-gel type process wherein a molecular precursor (typically tetraethylorthosilicate) is first reacted with water in an alcoholic solution, the resulting molecules then joining together to build larger structures. The reaction produces silica particles with varying diameters, depending on conditions (Scheme 1).

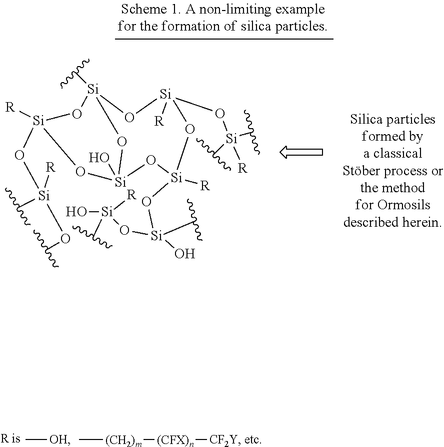

This disclosure provides various embodiments of a silica particle comprising G1:

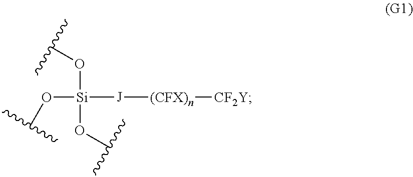

wherein
J is —(CH₂)ₘ—, —CH₂—O—CH₂—, an amide, urea, imide, or carbamate;
each X is independently H or F;
Y is H or F;
m is 2-6; and
n is 1-3;

wherein the silica particle has a diameter of about 0.001 micrometers to about 100 micrometers.

In some embodiments, m is 0 to 10, or 1-8. On other embodiments, n is 1-6, 5, 4, 3, 2, or 1. In additional embodiments, the Si atom of G1 is linked to the CFX moiety by an ether moiety. In other embodiments, J is —C(C═O)NR^{c}—, —NR^{c}C(═O)NR^{c}—, —(O═C)NR^{c}(C═O)—, or —OC(C═O)NR^{c}—., wherein each R^{c} is independently (C₁-C₆)alkyl.

This disclosure provides various other embodiments of a silica particle comprising G1b:

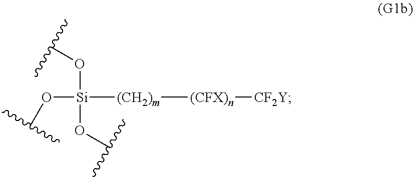

wherein
each X is independently H or F;
Y is H or F;
m is 1-10; and
n is 1-6; and

wherein the silica particle has a diameter of about 0.1 to about 10 micrometers.

Various non-limiting embodiments of are G1b are shown by example in Table 1.

TABLE 1
Embodiments of G1b. For example:

| when m is 1-7, —(CH₂)ₘ— is | when n is 1-4, —(CFX)ₙ— is | —CF₂Y is |
|---|---|---|
| —CH₂— | —CHF— | —CF₂H |
| —(CH₂)₂— | —CF₂— | —CF₃ |
| —(CH₂)₃— | —(CHF)₂— | |
| —(CH₂)₄— | —(CF₂)₂— | |
| —(CH₂)₅— | —(CHF)₃— | |
| —(CH₂)₆— | —(CF₂)₃— | |
| —(CH₂)₇— | —(CHF)₄— | |
| —(CH₂)₇— | —(CF₂)₄— | |

In some additional embodiments, the silica particle comprises more than about 5 wt % of G1. The wt % of G1 can be more than about 1%, more than about 10%, or it can be about 5 wt % to about 50 wt %. In other embodiments, each X is F. In some other embodiments, Y is F. in other embodiments, J is —(CH₂)ₘ— and m is 2.

This disclosure provides additional embodiments of the above described silica particle wherein G1 is G2:

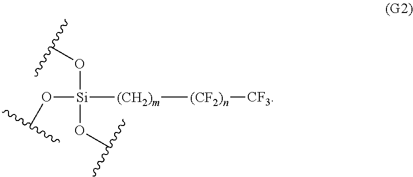

Some specific non-limiting examples from Table 1 of a silica particle comprising G1 are provided below wherein the above described silica particle G1 is G3:

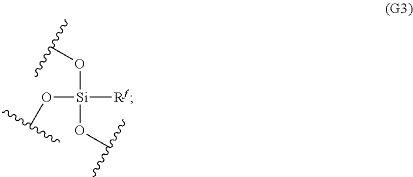

and

wherein R^{f} is: —(CH₂)₂CHFCHF₂, —(CH₂)₂CF₂CF₃, —(CH₂)₃CF₂CF₃, —(CH₂)₄CF₂CF₃, —(CH₂)₂(CHF)₂CHF₂, —(CH₂)₂(CHF)₃CHF₂, —(CH₂)₂(CF₂)₂CF₃, —(CH₂)₂(CF₂)₃CF₃, —(CH₂)₃(CHF)₂CHF₂, —(CH₂)₃(CHF)₃CHF₂, —(CH₂)₃(CF₂)₂CF₃, —(CH₂)₃(CF₂)₃CF₃, —(CH₂)₄(CHF)₂CHF₂, —(CH₂)₄(CHF)₃CHF₂, —(CH₂)₄(CF₂)₂CF₃, —(CH₂)₄(CF₂)₃CF₃, etc.

This disclosure further provides a substrate coated with a plurality of the disclosed silica particles wherein the surface of the coated substrate is liquid-repellant. In other embodiments, the liquid-repellant surface is omniphobic or superomniphobic. In various embodiments, the liquid repellant surface is superomniphobic, and a liquid in contact with the superomniphobic surface has a contact angle of about 150 degrees or more and a roll off angle of about 10 degrees or less.

Also, this disclosure provides a liquid repellant surface comprising a substrate coated with modified silica particles, wherein the modified silica particles are formed by hydrolysis and condensation of a compound of Formula A:

Si(Q^{a})₃-J-(CFX)ₙ—CF₂Y (A);

and a compound of Formula B:

Si(Q^{b})₄ (B);

wherein
Q^{a} and Q^{b} are each independently halo or —OR;
J is —(CH₂)ₘ—, —CH₂—O—CH₂—, an amide, urea, imide, or carbamate;
each X is independently H or F;
Y is H or F;
m is 2-6;
n is 1-3; and
each R is independently branched or unbranched —(C₁-C₆)alkyl;

wherein the mole ratio of compounds A:B is about 0.5 or greater and the surface of the coated substrate is liquid-repellant.

In some preferred embodiments wherein Q^{a} or Q^{b} is halo, halo is chlorine or bromine. In some embodiments of Formula A, only two Q^{a}'s are halo or alkoxy (—OR), wherein the third Q^{a} is —(C₁-C₆)alkyl. Similarly, in some embodiments of Formula AB only two Q^{b}'s are halo or alkoxy (—OR), wherein the third Q^{b} is —(C₁-C₆)alkyl.

Alternatively, this disclosure provides a liquid repellant surface comprising a substrate coated with modified silica particles, wherein the modified silica particles are formed by hydrolysis and condensation of a compound of Formula A2:

Si(OR^{a})₃—(CH₂)ₘ—(CFX)ₙ—CF₂Y (A2);

and a compound of Formula B2:

Si(OR^{b})₄ (B2);

wherein
R^{a} and R^{b} are each independently branched or unbranched —(C₁-C₆)alkyl;
each X is independently H or F;
Y is H or F;
m is 2-6; and
n is 1-3;

wherein the mole ratio of compounds A2:B2 is greater than about 0.7 and the surface of the coated substrate is superomniphobic.

In some embodiments, the mole ratio is about 0.8 to about 2.0 (e.g., A:B, A2:B2, or C:D). The mole ratio can also be about 0.1 or more. In other embodiments, A is a nonafluorohexyltriethoxysilane or a nonafluorohexyl(trialkoxy)silane. In yet other embodiments or the disclosure herein, the (modified) silica particle(s) has/have a diameter of about 0.001 to about 100 micrometers. The diameter can also be about 0.01 micrometers to about 50 micrometers, about 1 micrometer to about 25 micrometers, or about 500 nanometers to about 5 micrometers.

In additional embodiments, the modified silica particles are less toxic than a corresponding silica particle formed from a compound of Formula A wherein n is more than 3, or more than 6 (or more than 5, or 4). In further embodiments, the modified silica particles have a shorter half-life, or bioaccumulate to a lesser extent, than a corresponding silica particle formed from a compound of Formula A wherein n is more than 3, or more than 6 (or more than 5, or 4).

Additionally, this disclosure provides a method of forming a liquid repellant surface comprising:
a) mixing a compound of Formula C:

Si(OR^{a})₃—(CH₂)ₘ—(CFX)ₙ—CF₂Y (C);

a compound of Formula D:

Si(OR^{b})₄ (D);

wherein
R^{a} and R^{b} are each independently branched or unbranched —(C₁-C₆)alkyl;
each X is independently H or F;
Y is H or F;
m is 2-6; and
n is 1-3;
   water, a base and a solvent to form organically modified silica particles (Ormosils);
b) isolating the Ormosils; and
c) coating a substrate with Ormosils;

wherein the Ormosils have a diameter of about 0.001 micrometers to about 100 micrometers; the mole ratio of compounds C:D is about 0.5 or greater and the coated substrate has a liquid-repellant surface; and a liquid in contact with the liquid-repellant surface has a contact angle of about 90 degrees or more.

In some embodiments, the mole ratio of compounds A:B (or C:D) is greater than about 0.7 and the coated substrate has a superomniphobic surface. In other embodiments, a liquid in contact with the superomniphobic surface has a contact angle of about 150 degrees or more and a roll off angle of about 10 degrees or less, and wherein the liquid is water or n-hexadecane. In various embodiments, the liquid in contact with the liquid repellant surface is aqueous, such as, but not limited to an acid, base or buffer. In other embodiments, the liquid is a polar or non-polar, organic solvent. In yet other embodiments, the liquid is a Newtonian or non-Newtonian fluid.

In some embodiments, the base is ammonium hydroxide. In other embodiments, the solvent is an alcohol, or a ketone. In yet other embodiments, the Ormosils have a diameter of about 0.1 to about 10 micrometers.

In further additional embodiments, the Ormosils have an environmental half-life that is sufficiently short to minimize bioaccumulation compared to other Ormosils.

This disclosure provides ranges, limits, and deviations to variables such as volume, mass, percentages, ratios, etc. It is understood by an ordinary person skilled in the art that a range, such as “number 1” to “number 2”, implies a continuous range of numbers that includes the whole numbers and fractional numbers. For example, 1 to 10 means 1, 2, 3, 4, 5, . . . 9, 10. It also means 1.0, 1.1, 1.2. 1.3, . . . , 9.8, 9.9, 10.0, and also means 1.01, 1.02, 1.03, and so on. If the variable disclosed is a number less than “number 10”, it implies a continuous range that includes whole numbers and fractional numbers less than number 10, as discussed above. Similarly, if the variable disclosed is a number greater than “number 10”, it implies a continuous range that includes whole numbers and fractional numbers greater than number 10. These ranges can be modified by the term “about”, whose meaning has been described above.

### Results and Discussion

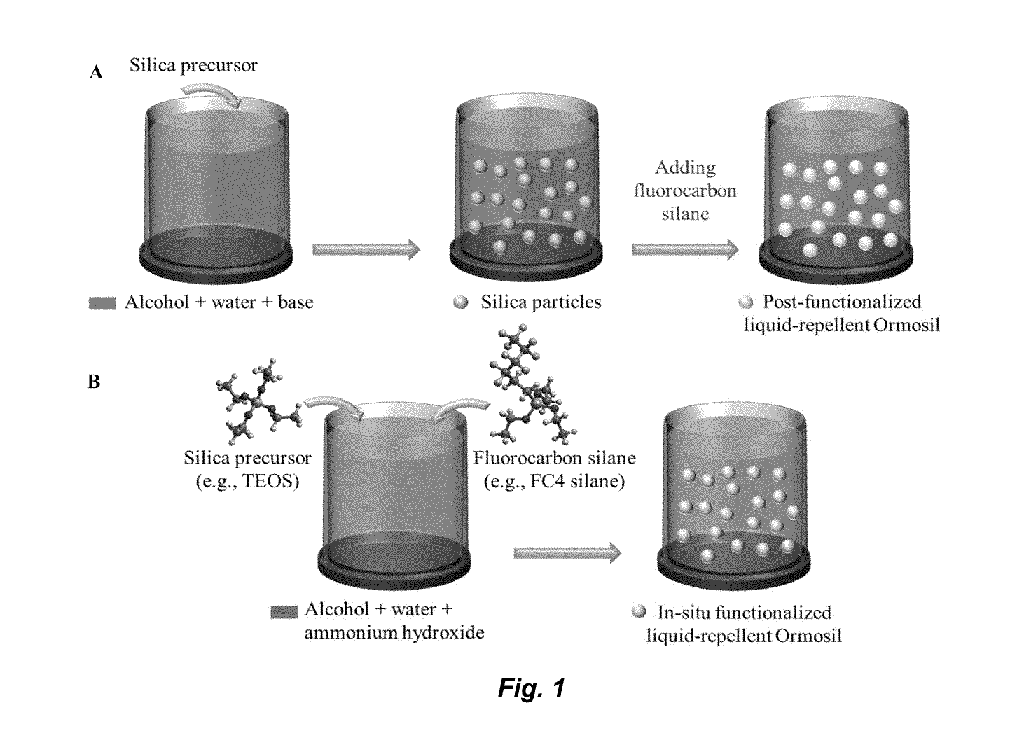

General Fabrication Procedure: Conventionally, superomniphobic surfaces are fabricated by synthesizing silica particles from silica precursors via Stöber synthesis and subsequently modifying the surface of the silica particles with self-assembled layers of fluorocarbon silanes (see FIG. 1a). Short chain fluorocarbon-based Ormosils fabricated with this conventional technique (i.e., post-functionalization of silica particles) lead to inferior liquid-repellency compared to long chain fluorocarbon-based Ormosils.

In this work, a method was developed a modified Stöber synthesis technique, which is a one-pot approach that combines the synthesis of silica particle from silica precursors with in-situ modification of the surface with fluorocarbon silanes (see FIG. 1b). Solvent and chemical reagents are added into a glass container, which is subsequently sealed and undergoes constant shaking for an appropriate amount of time to synthesis Ormosils. The disclosed modified Stöber synthesis process enables the fabrication of Ormosils through in-situ hydrolysis and co-condensation of a short chain fluorocarbon silane along with the silica precursor. The liquid-repellency of the in-situ functionalized short chain fluorocarbon-based Ormosils match the liquid-repellency of long chain fluorocarbon-based Ormosils.

An appropriate amount of methanol used as solvent is first added into a glass container. The solvent may be other alcohols, including (but not limited to) ethanol and isopropyl alcohol. An appropriate amount of deionized water is then added into the glass container. An appropriate amount of tetraethyl orthosilicate (TEOS), which is a silica precursor, is then added into the glass container. The silica precursor may be other chemical reagents, including (but not limited to) tetramethyl orthosilicate (TMOS) and tetrapropyl orthosilicate (TPOS). An appropriate amount of ammonia hydroxide used as catalyst is then added into the mixture. Subsequently, an appropriate amount of a short chain fluorocarbon silane containing only 4 perfluorinated carbons is added into the mixture. The short chain fluorocarbon silanes may be (but not limited to) nonafluorohexyltriethoxysilane, nonafluorohexyltrimethoxysilane, and nonafluorohexyltrichlorosilane.

The solution is placed on a shaker and the reaction is conducted at room temperature for an appropriate amount of time. The in-situ functionalized short chain fluorocarbon-based Ormosils are washed via centrifugation using alcohols. The superomniphobic particles are obtained by drying the washed particles at room temperature. The Ormosils-based superomniphobic surfaces are fabricated through spray coating, drop casting, or spin coating of in-situ functionalized short chain fluorocarbon-based Ormosils on a substrate. The substrate may be (but not limited to) glass, plastic, and metals.

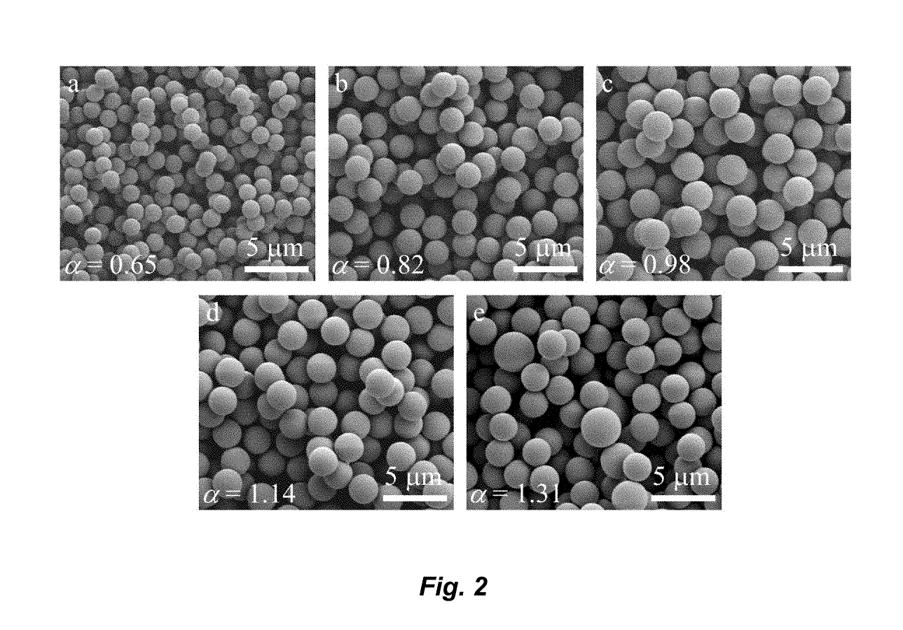

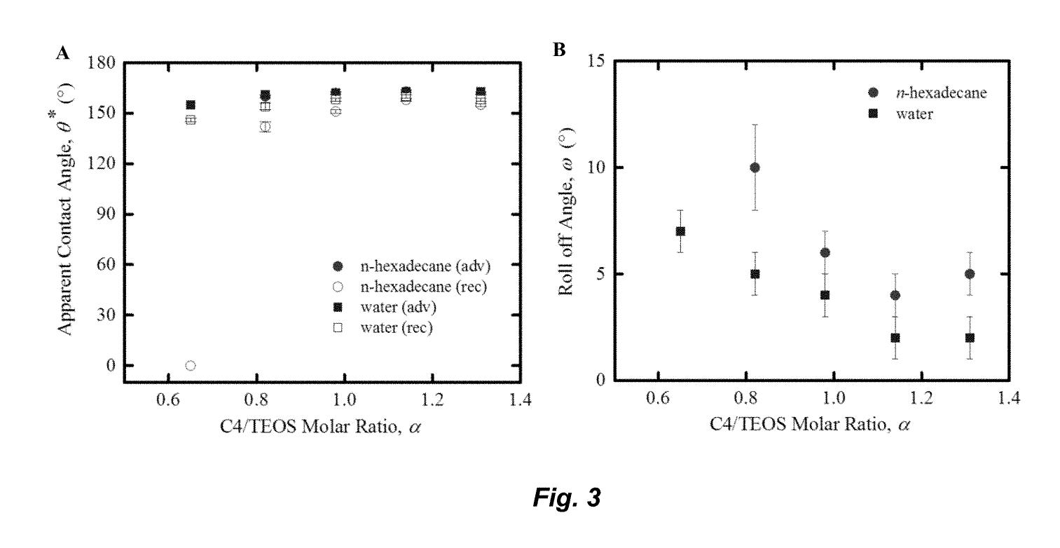

Results: FIG. 2 shows the morphology of in-situ functionalized short chain fluorocarbon-based Ormosils, which are synthesized at different molar ratio of nonafluorohexyltriethoxysilane to TEOS (0.65 to 1.31). By varying the amount of solvent and chemical reagents as well as the reaction time, Ormosils with different size can be synthesized. FIG. 3a shows the apparent contact angles of water (a representative liquid with high surface tension, γₗᵥ≈72.1 mN/m) and n-hexadecane (a representative liquid with high surface tension, γₗᵥ≈27.5 mN/m) droplets on the Ormosils-based superomniphobic surfaces, which are fabricated by drop casting of the Ormosils on a glass slide.

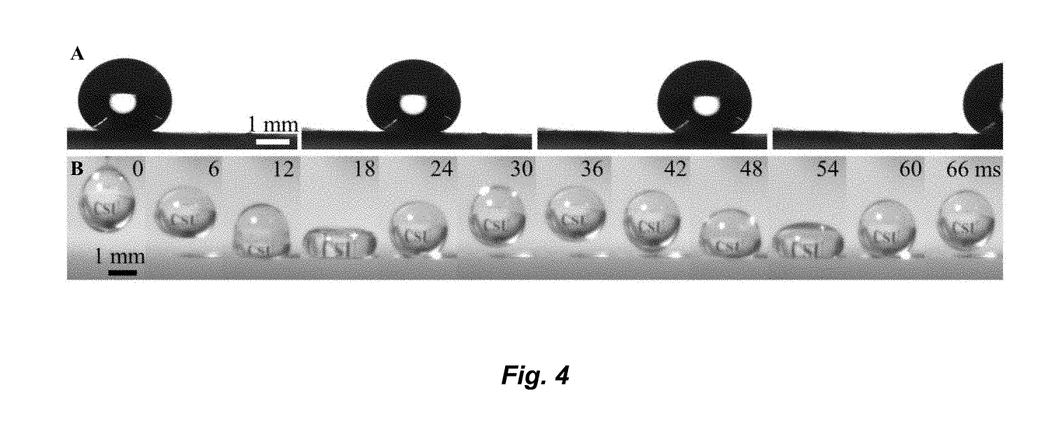

For Ormosils with molar ratio a of nonafluorohexyltriethoxysilane to TEOS greater than 0.82, the Ormosils-based surfaces exhibit superomniphobicity, as evidenced by the high apparent advancing contact angle (>150°) and apparent receding contact angle (>150°) for both water and n-hexadecane. Both water and n-hexadecane droplets display low roll off angles (<10°) on these Ormosils-based superomniphobic surfaces (see FIG. 3b). The results of apparent contact angles and roll off angles indicate that the disclosed short chain fluorocarbon-based Ormosils superomniphobic surfaces possess superior liquid-repellency that is equivalent to long chain fluorocarbon-based superomniphobic surfaces, on which water and n-hexadecane typically display apparent contact angle >150° and roll off angle <10°. Due to the superomniphobicity of the described short chain fluorocarbon-based Ormosils surfaces, liquid droplets with different properties can easily roll off and bounce on these surfaces (see FIG. 4).

The disclosed sustainable superomniphobic surfaces have numerous applications including (but not limited to) corrosion prevention, fluid drag reduction, liquid waste reduction, chemical shielding, self-cleaning, anti-fouling, anti-bacteria, gravity-driven membrane separation, and enhanced condensation heat transfer coefficients.

The following Example intended to illustrate the above invention and should not be construed as to narrow its scope. One skilled in the art will readily recognize that the Examples suggest many other ways in which the invention could be practiced. It should be understood that numerous variations and modifications may be made while remaining within the scope of the invention.

### EXAMPLE

### Example 1

### Preparation of Modified Silica Particles

0.5 ml of deionized water, 0.8 ml of TEOS (Sigma-Aldrich), 0.1 ml of ammonia hydroxide (Fisher Chemical) and 1.2 ml of nonafluorohexyltriethoxysilane (Gelest) were added into a glass bottle containing 15 ml of methanol (Fisher Chemical). The bottle was then sealed and placed on a shaker at 400 rpm for 63 hours at room temperature. The in-situ functionalized short chain fluorocarbon-based Ormosils were then washed with methanol for 5 times via centrifugation at 1000 rpm for 10 minutes. The superomniphobic particles were obtained by drying the washed particles at room temperature for 2 hours. The Ormosils-based superomniphobic surfaces were fabricated by drop casting of the washed particles on a glass slide.

The amounts of solvent and chemical reagents can be varied in order to synthesize the in-situ functionalized short chain fluorocarbon-based Ormosils. For example, the amount of solvent can be varied from 1 ml to 1 L. The amount of silica precursor can be varied from 0.01 ml to 0.2 L. The amount of short chain fluorocarbon silane can be varied from 0.01 ml to 0.6 L. The amount of water can be varied from 0.01 ml to 0.5 L. The amount of ammonia hydroxide can be varied from 0.001 ml to 0.2 L. Additionally, the synthesis time can be varied from 0.5 hour to 72 hours.

While specific embodiments have been described above with reference to the disclosed embodiments and examples, such embodiments are only illustrative and do not limit the scope of the invention. Changes and modifications can be made in accordance with ordinary skill in the art without departing from the invention in its broader aspects as defined in the following claims.

All publications, patents, and patent documents are incorporated by reference herein, as though individually incorporated by reference. No limitations inconsistent with this disclosure are to be understood therefrom. The invention has been described with reference to various specific and preferred embodiments and techniques. However, it should be understood that many variations and modifications may be made while remaining within the spirit and scope of the invention.

What is claimed is:

1. A silica particle comprising G1: 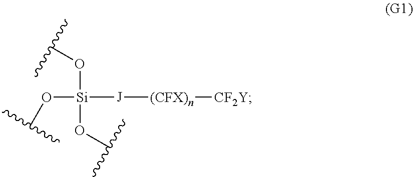
wherein
J is —(CH₂)ₘ—, —CH₂—O—CH₂—, an amide, urea, imide, or carbamate;
each X is independently H or F;
Y is H or F;
m is 2-6; and
n is 1-3;
wherein the silica particle has a diameter of about 0.001 micrometers to about 100 micrometers.

2. The silica particle of claim 1 wherein the silica particle comprises more than about 5 wt % of G1.

3. The silica particle of claim 1 wherein each X is F.

4. The silica particle of claim 1 wherein Y is F.

5. The silica particle of claim 1 wherein J is —(CH₂)ₘ— and m is 2.

6. The silica particle of claim 1 wherein G1 is G2:

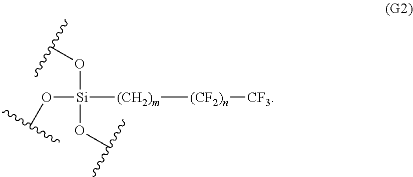

7. A substrate coated with a plurality of silica particles according to claim 1 wherein the surface of the coated substrate is liquid-repellant.

8. The substrate of claim 7 wherein the liquid-repellant surface is omniphobic or superomniphobic.

9. The substrate of claim 8 wherein the liquid repellant surface is superomniphobic, and a liquid in contact with the superomniphobic surface has a contact angle of about 150 degrees or more and a roll off angle of about 10 degrees or less.

10. A liquid-repellant surface comprising a substrate coated with modified silica particles, wherein the modified silica particles are formed by hydrolysis and condensation of a compound of Formula A:
Si(Q^{a})₃-J-(CFX)ₙ—CF₂Y (A);
and a compound of Formula B:
Si(Q^{b})₄ (B);
wherein
Q^{a} and Q^{b} are each independently halo or —OR;
J is —(CH₂)ₘ—, —CH₂—O—CH₂—, an amide, urea, imide, or carbamate;
each X is independently H or F;
Y is H or F;
m is 2-6;
n is 1-3; and
each R is independently branched or unbranched —(C₁-C₆)alkyl;
wherein the mole ratio of compounds A:B is about 0.5 or greater and the surface of the coated substrate is liquid-repellant.

11. The liquid-repellant surface of claim 10 wherein the mole ratio is about 0.8 to about 2.0.

12. The liquid-repellant surface of claim 11 wherein A is a nonafluorohexyl(trialkoxy)silane.

13. The liquid-repellant surface of claim 10 wherein the modified silica particles have a diameter of about 0.001 micrometers to about 100 micrometers.

14. The liquid-repellant surface of claim 10 wherein the modified silica particles are less toxic than a corresponding silica particle formed from a compound of Formula A wherein n is more than 6.

15. The liquid-repellant surface of claim 14 wherein the modified silica particles have a shorter half-life, or bioaccumulate to a lesser extent, than a corresponding silica particle formed from a compound of Formula A wherein n is more than 3.

16. A method of forming a liquid-repellant surface comprising:
a) mixing a compound of Formula C:
Si(OR^{a})₃—(CH₂)ₘ—(CFX)ₙ—CF₂Y (C);
a compound of Formula D:
Si(OR^{b})₄ (D);
wherein
R^{a} and R^{b} are each independently branched or unbranched —(C₁-C₆)alkyl;
each X is independently H or F;
Y is H or F;
m is 2-6; and
n is 1-3;
water, a base and a solvent to form organically modified silica particles (Ormosils);
b) isolating the Ormosils; and
c) coating a substrate with Ormosils;
wherein the Ormosils have a diameter of about 0.001 micrometers to about 100 micrometers;
wherein the mole ratio of compounds C:D is about 0.5 or greater and the coated substrate has a liquid-repellant surface; and
wherein a liquid in contact with the liquid-repellant surface has a contact angle of about 90 degrees or more.

17. The method of claim 16 wherein the base is ammonium hydroxide.

18. The method of claim 16 wherein the solvent is an alcohol.

19. The method of claim 16 wherein the Ormosils have a diameter of about 0.1 micrometers to about 10 micrometers.

20. The method of claim 16 wherein the Ormosils have an environmental half-life that is sufficiently short to minimize bioaccumulation compared to other Ormosils.
